(19) United States
(12) Patent Application Publication
(10) Pub. No.: US 2012/0321801 A1
(43) Pub. Date: Dec. 20, 2012

(54) CLEANING COMPOSITION FOR BONDING PREPARATION OF AEROSPACE MATERIALS

(76) Inventor: James F. Cordaro, Ridgecrest, CA (US)

(21) Appl. No.: 13/162,516

(22) Filed: Jun. 16, 2011

(51) Int. Cl. B08B 3/00; C11D 17/00; B05D 3/00; C11D 17/08

(52) U.S. Cl. 427/299; 510/365; 134/26

(57) ABSTRACT

A composition for removing silicone oils from a material and methods of using the same are disclosed. The composition and methods may be used to prepare a material for bonding. The composition may be a liquid cleaning composition including a strong base, a soap, an abrasive, and water.

### FIELD

One or more embodiments of the present invention relate to compositions for removing silicone oils from a material and methods of using the same. More generally, embodiments of the present invention are directed to compositions for preparing materials for bonding and coating, and methods of using the same.

### BACKGROUND

Chemical contamination of aerospace materials is a significant problem for the aerospace industry. In particular, silicone contamination from chemicals, such as mold releases, interferes with the bonding of aerospace parts. Typically, silicone contamination manifests itself by the failure of a bond between materials. Once a bond failure is detected, the failed part must be reworked, if possible. If the part can be reworked, the silicone contamination is mitigated by flushing the part with high purity hexanes. The silicone oil is flushed away along with the used hexanes, resulting in significant waste. Additionally, the hexanes, which contain the silicone oil residue, can splash back onto the part, thereby re-contaminating the part with silicone oils, resulting in a very labor intensive process that is not 100% reliable. If the part cannot be reworked, the part is disposed of, resulting in significant additional manufacturing costs. Another method for mitigation of silicone oil contamination is oxygen plasma etching. Plasma etching involves expensive equipment and might not be suitable for large parts, such as those having dimensions of several feet or more. Accordingly, there is a need for a cleaning composition that can quickly, cheaply, and reliably remediate silicone contamination of materials and prepare those materials for bonding, particularly in the aerospace industry.

### SUMMARY

An aspect of one or more embodiments of the present invention is generally directed to a liquid cleaning composition including: a strong base; a soap; an abrasive; and water.

In certain embodiments, the strong base is selected from the group consisting of sodium hydroxide (NaOH), potassium hydroxide (KOH), lithium hydroxide (LiOH), and trisodium phosphate (TSP).

The strong base may be present in the liquid cleaning composition in an amount in a range of about 1 to about 10% by weight based on the total weight of the liquid cleaning composition.

For example, the strong base may be present in the liquid cleaning composition in an amount of about 3% by weight based on the total weight of the liquid cleaning composition.

The soap may be present in the liquid cleaning composition in an amount in a range of about 1 to about 10% by weight based on the total weight of the liquid cleaning composition.

The abrasive may be present in the liquid cleaning composition in an amount in a range of about 10 to about 25% by weight based on the total weight of the liquid cleaning composition.

In certain embodiments, the abrasive and the soap may be present in the liquid cleaning composition in a combined amount of about 20% by weight based on the total weight of the liquid cleaning composition.

Water may be present in the liquid cleaning composition in an amount in a range of about 65 to about 85% by weight based on the total weight of the liquid cleaning composition.

For example, water may be present in the liquid cleaning composition in an amount of about 77% by weight based on the total weight of the liquid cleaning composition.

In certain embodiments, the abrasive includes calcite or calcium carbonate obtained from limestone.

In other embodiments, the abrasive includes feldspar.

In certain embodiments, the abrasive includes calcite and feldspar.

The soap may include sodium tallowate.

The soap may include sodium palmitate.

In certain embodiments, the liquid cleaning composition has a pH greater than or equal to about 11.

An aspect of one or more embodiments of the present invention is also generally directed to a method of cleaning a material, the method including: applying a liquid cleaning composition according to any of the above to the material; scrubbing the material with the liquid cleaning composition; rinsing the material with water, which may be tap water; rinsing the material with deionized water; and drying the material. In certain embodiments, the material may be an aerospace material.

In certain embodiments, the aerospace material includes a material selected from the group consisting of glass fiber reinforced epoxy matrix composites and graphite fiber reinforced epoxy matrix composites, of a metal selected from the group consisting of aluminum, aluminum alloys, titanium, titanium alloys, beryllium, beryllium alloys, and combinations thereof

Another aspect of one or more embodiments of the present invention is generally directed to a method of bonding materials, the method including: cleaning the material according to any of the above; and bonding the material to an inorganic thermal control coating. Again, in certain embodiments, the material may be an aerospace material.

The inorganic thermal control coating may include a potassium silicate binder based coating.

### BRIEF DESCRIPTION OF THE DRAWINGS

The accompanying drawings, together with the specification, illustrate exemplary embodiments of the present invention, and, together with the description, serve to explain the principles of the invention.

FIG. 1 is a block diagram that exemplifies a general process by which an exemplary embodiment of a liquid cleaning composition can be prepared.

FIG. 2 is a block diagram that exemplifies a general process by which another exemplary embodiment of a liquid cleaning composition can be prepared.

FIG. 3 is a block diagram that exemplifies a general process by which a material can be cleaned using a cleaning composition according to embodiments of the present invention and bonded with an adhesive to another material.

FIG. 4 is a block diagram that exemplifies a general process by which a material can be cleaned using a cleaning composition according to embodiments of the present invention and coated with an inorganic thermal control coating.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein.

Embodiments of the present invention are directed to compositions for use in the removal of silicone (e.g., silicone oil) from materials (i.e., substrates), such as aerospace materials, and methods of using such compositions. More generally, the compositions of the present invention are useful for the preparation of materials, such as aerospace materials, for structural or non-structural bonding. In certain embodiments, the composition is a liquid cleaning composition configured to remove silicone contamination by promoting the degradation of silicone. For example, embodiments of the liquid cleaning composition are configured to promote the degradation of silicone by breaking at least one silicon-oxygen bond in the silicone (i.e., the backbone of the chain) and by forming at least one new silicon-oxygen bond to thereby form water soluble alkali silicates (e.g., “water glasses”). Dilute water soluble alkali silicates are environmentally benign and can be washed away by the liquid cleaning composition. The liquid cleaning composition also removes dirt, grease, and organic oils from the surface of the material.

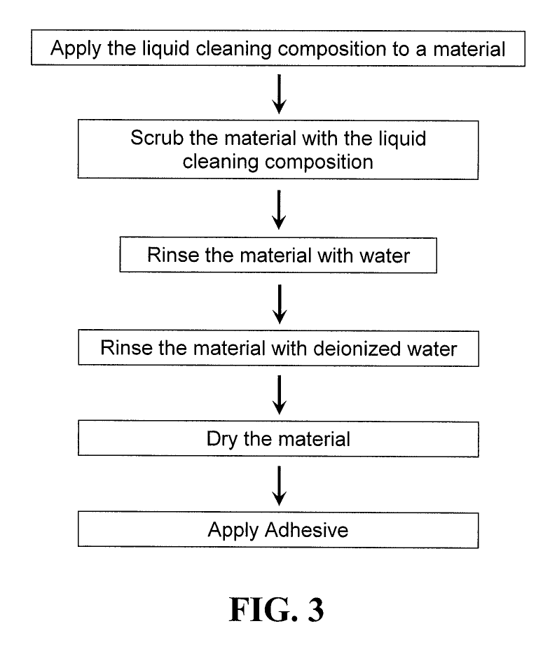

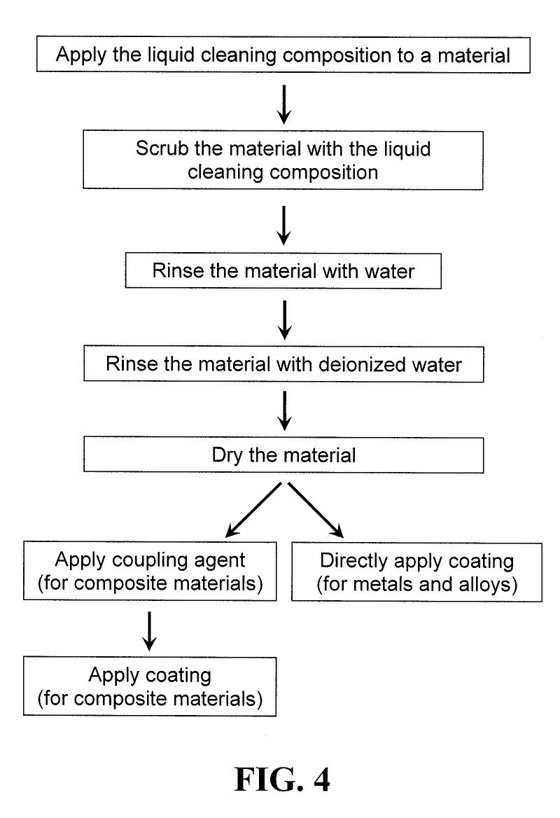

Previously, simple and economical methods of removing silicone from as-received composite aerospace materials did not exist. The present inventor has discovered, by the application of knowledge in inorganic chemistry, surface science, polymer chemistry, ceramic and glass science, and spacecraft and satellite design and manufacturing, that a liquid cleaning composition according to embodiments of the present invention (i.e., having a suitable composition and mixing ratio) can effectively remove silicone contamination from aerospace materials. By removing silicone contamination, embodiments of the present invention can provide aerospace materials having a pristine, clean, and/or polar surface suitable for bonding using adhesives (as shown in FIG. 3), attachment of coupling agents (as shown in FIG. 4), or direct bonding of inorganic paints and coating without a primer (as shown in FIG. 4).

For example, an embodiment of the present invention can remove silicone contamination from a material selected from the group consisting of glass fiber reinforced epoxy matrix composites and graphite fiber reinforced epoxy matrix composites, or a material selected from the group consisting of aluminum, aluminum alloys, titanium, titanium alloys, beryllium, beryllium alloys, and combinations thereof, and the material can then be directly bonded to an inorganic thermal control coating, without the use of either coupling agents, rub priming, or heavy abrasion. In the case of glass fiber reinforced epoxy matrix composites (e.g., G10 glass fiber reinforced epoxy matrix composites) and graphite fiber reinforced epoxy matrix composites, the liquid cleaning composition develops a polar and hydroxylated surface on the material, resulting in a surface that is more hydrophilic than hydrophobic, thereby making the surface more amenable to bonding to adhesives, such as epoxy adhesives. Such a prepared surface is capable of producing a much stronger bond than a surface in as-received condition, or a surface that has undergone only solvent wiping. Additionally, embodiments of the liquid cleaning composition remove the heavy, native oxide from the surface of the above-described metals and alloys by chemical means. After being treated with the liquid cleaning composition, an inorganic thermal control coating (e.g., a potassium silicate binder based coating) can be directly sprayed on the material (i.e., substrate) and cured to provide excellent adhesion.

Previously, there were no known methods for direct bonding of inorganic thermal control coatings to titanium metal. Additionally, methods for direct bonding of inorganic thermal control coatings to aluminum alloys did not exist. For example, aluminum alloys typically have been prepared for bonding of inorganic coatings by way of rub-priming, which is very labor intensive. Generally, rub-priming involves the following eight separate steps: (a) washing the material with soap and water; (b) rinsing the material with water (e.g., tap water); (c) rinsing the material with deionized water; (d) drying the material with nitrogen gas or filtered air; (e) solvent wiping the material with methyl ethyl ketone (MEK); (f) abrading the surface of the material using sandpaper or an abrasive pad; (g) rub-priming the surface of the material with a small amount of the liquid coating; and (h) removing the excess rub-prime from the surface of the material with a Texwipe cloth and deionized water.

In contrast, the present inventor has discovered that embodiments of the present invention can eliminate or reduce the need for process steps typically required prior to the application of an inorganic thermal control coating. That is, embodiments of the present invention eliminate or reduce the need for rub priming or heavy abrasion prior to the application of an inorganic thermal control coating. Because heavy abrasion is not required for embodiments of the present invention, the present inventor believes that the above-described coatings to the material act by way of chemical means rather than a mechanical means. For example, according to an embodiment of the present invention, the previous eight rub-priming steps are reduced to the following simple steps: applying the liquid cleaning composition to a material; scrubbing the material with the liquid cleaning composition (which may include scrubbing with a pad or other suitable abrasive); rinsing the material with water (e.g., tap water); rinsing the material with deionized water; and drying the material (e.g., drying the material with compressed nitrogen gas or filtered air). After the material is dry, it is immediately ready for spray coating, which was not possible according to previously known methods of preparing aerospace materials.

In certain embodiments, the liquid cleaning composition includes: a strong base; a soap; an abrasive; and water. The strong base of the liquid cleaning composition is configured to promote the degradation of silicone by breaking at least one silicon-oxygen bond in the silicone and forming at least one new silicon-oxygen bond to thereby form water soluble alkali silicates.

The strong base may be selected from the group consisting of sodium hydroxide (NaOH), potassium hydroxide (KOH), lithium hydroxide (LiOH), and trisodium phosphate (TSP). In certain embodiments, the strong base is selected from the group consisting of NaOH and KOH. In particular, the strong base may be NaOH. While the strong base may include LiOH, it is a less desirable base due to its toxicity and its propensity to attack and/or corrode metal substrates. Additionally, the strong base may include TSP, but TSP is a less desirable base due to its potential environmental impact.

Without being limited by theory, the present inventor believes that the strong base performs at least two functions in the liquid cleaning composition. First, it is believed that the strong base (e.g., NaOH), possibly in combination with abrasives, removes the native surface oxide on aluminum and titanium metal substrates to prepare a pristine surface with no visible oxidation layer. Such a pristine surface is required to perform coating with an inorganic thermal control coating without primers, rub-priming, or heavy abrasion. Second, it is believed that the strong base attacks and breaks down silicone oils, such as polydimethylsiloxane, to form water soluble silicates that can be carried away, for example, by the abrasives and/or soaps. This leaves a surface substantially free of silicone contamination. As used herein, the term “a surface substantially free of silicone contamination” means a surface that is completely free of silicone oils, greases, or resins, or a surface that includes silicone oil, grease, or resin such that the silicone oil contamination is reduced to a level whereby satisfactory bonding or adhesion can occur.

In certain embodiments, the strong base is present in the liquid cleaning composition in an amount in a range of about 1 to about 10% by weight based on the total weight of the liquid cleaning composition. For example, the strong base may be present in the liquid cleaning composition in an amount of about 3% by weight based on the total weight of the cleaning composition.

The water soluble alkali silicates formed by the liquid cleaning composition and silicone may include an alkali cation (e.g., sodium, potassium, or lithium) from the strong base (e.g., the alkali hydroxide or TSP). Once the silicone and the liquid cleaning composition have reacted to form water soluble alkali silicates, the residues of the water soluble alkali silicates can be suspended within the soap solution of the liquid cleaning composition, and can then be rinsed away with water or another suitable solvent. As such, the liquid cleaning composition may include a soap acting as a surfactant to carry away particulate solids and solubilized residues from the surface of the part. For example, the liquid cleaning composition may include the soap in an amount in a range of about 1 to about 10% by weight based on the total weight of the liquid cleaning composition. In certain embodiments, the liquid cleaning composition includes the soap in an amount of about 10% by weight based on the total weight of the liquid cleaning composition.

A soap is a salt of a fatty acid. It is obtained by treating vegetable or animal oils and fats with a strongly alkaline solution. A soap has a non-polar, long saturated hydrocarbon chain. One end of the chain includes a polar carboxylate group having an attached sodium, potassium, or lithium cation. Sodium tallowate, for example, is one kind of an animal-derived soap. Sodium palmitate, for example, is one kind of a plant-derived soap. A synthetic detergent is distinguished from soap by having a different molecular structure and may be of the anionic, cationic, or non-ionic variety. Additionally, synthetic detergents function differently from soap. Soaps promote different behaviors, such as the formation of suds. While non-ionic detergents may be useful for the removal of certain residues, such as dried food, the use of non-ionic detergents is not preferred for certain embodiments of the present invention. Examples of a synthetic detergent of the anionic variety include sodium dodecyl sulfate and sodium dodecylbenzenesulfonate. Cationic detergents have a quaternary ammonium salt as the hydrophylic end. One example of a synthetic detergent of the cationic variety is dodecyltrimethylammonium bromide. One example of a synthetic detergent of the nonionic variety is decaethylene glycol monododecyl ether. Although not preferred, in certain embodiments, a cationic or anionic detergent may be used in addition to or in place of the soap.

The soap, and the liquid cleaning composition, preferably should not include any colored dyes, perfumes, or chlorinated chemicals that can contaminate or corrode the aerospace material. For example, chlorine may contribute to the corrosion of the aerospace material. Accordingly, certain embodiments of the present invention are substantially free of color dyes, perfumes, and chlorinated compounds. As used herein, the term “substantially free of color dyes, perfumes, and chlorinated compounds” means that the liquid cleaning composition is completely free of color dyes, perfumes and chlorinated compounds, or that color dyes, perfumes, and chlorinated compounds are only present in the liquid cleaning composition as minor impurities.

Because certain embodiments of the liquid cleaning composition will have a pH of greater than or equal to about 11, the soap should be compatible with such a high pH environment. Additionally, the soap should be configured to be rinsed clean without leaving substantial chemical residues, and the soap should not cause excessive foaming. The soap may be sodium or potassium tallowate, sodium or potassium palmitate, or similar alkali salts of fatty acid molecules. Exemplary soaps can be found in Bon Ami formula 1886 cleanser. As-received Bon Ami, however, includes too much soap relative to the abrasives. Use of the as-received Bon Ami results in excessive foaming, which leads to poor cleaning of the material and difficulty in rinsing the cleaner from the material. Additionally, excessive foaming prevents the required mixing of the ingredients when shaking the container in which the liquid cleaning composition is stored. That is, excessive foaming fills the head space of the container and it becomes more difficult to uniformly disperse the abrasives in the liquid cleaning composition. Therefore, Bon Ami must be modified as described below in greater detail.

In certain embodiments, the soap is sodium tallowate. Additionally, the water soluble alkali silicates (i.e., water glasses), formed from the reaction of silicone and the liquid cleaning composition, are also anionic detergents. Indeed, water glasses are one of the oldest known detergents, and were used as laundry detergents in the early 20th century. Water glasses are added to present day powdered laundry detergents as both a cleaning agent and an anti-caking agent.

In addition, embodiments of the liquid cleaning composition also include abrasives, such as particulate abrasives. For example, the liquid cleaning composition may include abrasives in an amount in a range of about 10 to about 25% by weight based on the total weight of the liquid cleaning composition. In certain embodiments, the liquid cleaning composition includes abrasives in an amount of about 15% by weight based on the total weight of the liquid cleaning composition. Additionally, in certain embodiments, the abrasives and soaps are present in the liquid cleaning composition in a combined amount of about 20% by weight based on the total weight of the liquid cleaning composition.

The abrasives may help remove native oxides, dirt, and/or other contamination, and the abrasives may bind with particulate solids and solubilized residues, and carry away said residues in the rinse process. The abrasives should be compatible with a high pH liquid (e.g., a liquid having a pH of greater than or equal to about 11), and should not be broken down or dissolved by the strong base. That is, the abrasives should be chemically and physically stable in a high pH environment. As such, exemplary abrasives include ceramic materials or minerals having a high Lewis basicity.

For example, embodiments of the liquid cleaning composition may include feldspar. In particular, the liquid cleaning composition may include feldspar in its anorthoclase form. Feldspar is a common mineral having the formula: (Na,K)AlSi₃O₈. Additionally, feldspar has a high Lewis basicity and the cations Na⁺ and K⁺, the ratio of which depends on the location in which the feldspar is mined. As such, feldspar has alkali cations and is compatible with liquids having a high pH (e.g., a pH greater than or equal to about 11). Alternatively, or additionally, embodiments of the liquid cleaning composition may include calcite or calcium carbonate derived from limestone. Calcium carbonate (CaCO₃), and particularly the calcite form of calcium carbonate, is a mineral having high Lewis basicity and a Ca²⁺ metal cation (e.g., an alkaline earth cation) that is compatible with high pH solutions. In certain embodiments, the liquid cleaning composition includes calcite and feldspar as the abrasive.

Furthermore, the abrasives should be friable, breaking down into smaller particles during use, to thereby help carry away residues. Specifically, calcite and anorthoclase feldspar are relatively soft abrasives. For example, calcite has a Mohs hardness of 3.0 and anorthoclase has a Mohs hardness of 6.0. In contrast, the Mohs hardness of corundum (i.e., alumina) is 9.0 and the Mohs hardness of quartz (SiO₂) is 7.0 on a scale of 1 to 10, diamond having a Mohs hardness of 10. Additionally, although alumina is a very common abrasive, the strong base (e.g., NaOH) of embodiments of the liquid cleaning composition will attack the alumina particulates, chemically breaking it down and combining with it, possibly forming a gelatinous mixture of aluminum hydroxides. As such, alumina would not be stable in a high pH environment, and therefore, is incompatible with certain embodiments of the present invention. Accordingly, certain embodiments of the present invention are substantially free of alumina. As used herein, the term “substantially free of alumina” means that the liquid cleaning composition is either completely free of alumina, or that alumina is only present in the liquid cleaning composition as a minor impurity.

Another common abrasive used in commercial powdered cleansers is quartz (i.e., SiO₂). Quartz is also incompatible with certain embodiments of the present invention. Small particulate quartz is also attacked by high pH bases, such as NaOH. Accordingly, certain embodiments of the present invention are substantially free of quartz. As used herein, the term “substantially free of quartz” means that the liquid cleaning composition is either completely free of quartz, or that quartz is only present in the liquid cleaning composition as a minor impurity.

Embodiments of the present invention also include water. For example, water may be present in the liquid cleaning composition in an amount in a range of about 60 to about 85% by weight based on the total weight of the liquid cleaning composition. In certain embodiments, water is present in an amount of about 77% by weight based on the total weight of the liquid cleaning composition. Water may help maintain a suitable ratio of soap, strong base, and abrasives in the liquid cleaning composition. Additionally, including water in a suitable amount may prevent the liquid cleaning composition from foaming excessively when used. Further, water provides that the liquid cleaning composition is sufficiently liquid for suitable washing of the part and for providing a uniform distribution of abrasives and soaps upon shaking the liquid cleaning composition.

The following examples are presented for illustrative purposes only and are not to be viewed as limiting the scope of the invention. Unless otherwise indicated, all parts and percentages in the following examples, as well as throughout the specification, are by weight.

An exemplary embodiment of the liquid cleaning composition includes: NaOH in an amount of about 3% by weight; Bon Ami 1886 formula powdered cleanser (modified as described below) in an amount of about 20% by weight; and water in an amount of about 77% by weight, wherein the % by weight is based on the total weight of the liquid cleaning composition.

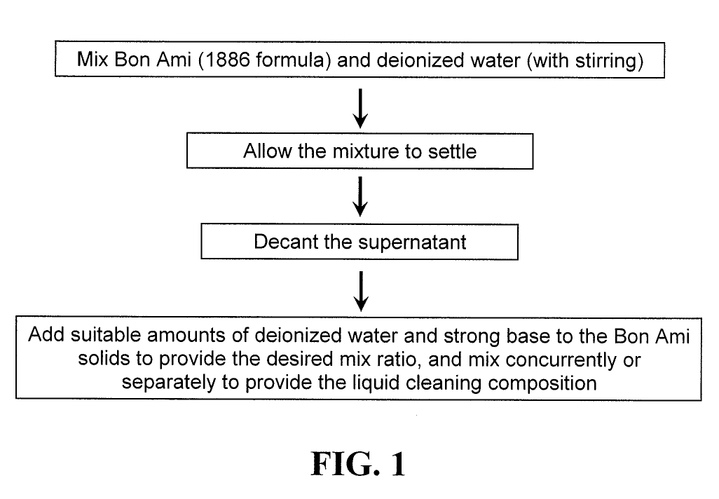

According to an exemplary embodiment of the present invention, a liquid cleaner can be prepared using Bon Ami 1886 formula, which has had about 75% of the water soluble soap extracted and discarded from the as-received Bon Ami, leaving the Bon Ami abrasives and about 25% of the original quantity of soap. FIG. 1 is a block diagram that exemplifies a general process by which an exemplary embodiment of a liquid cleaning composition can be prepared from modified Bon Ami. The modified Bon Ami can be prepared as follows. Mix 100 g of Bon Ami® powdered cleanser (1886 formula) and 400 g of deionized water in a glass beaker, with stirring. Allow the solution to settle overnight. After settling overnight, decant about 300 g of clear liquid (i.e., the supernatant) from the beaker. The Bon Ami solids should remain in the beaker. Add a suitable amount of deionized water (generally about 285 g) to the beaker to provide a solution including water and Bon Ami solids. Add a suitable amount of reagent grade solid NaOH (generally about 15 g) to the beaker to provide a 500 g solution having a composition of about 77 wt % water, about 20 wt % Bon Ami solids, and about 3 wt % NaOH. Stir the solution to dissolve the NaOH. The dissolved mixture can then be poured into an appropriate storage or shipping bottle (e.g., a bottle having 1,000 mL or 32 oz. capacity). The bottle will be about one half full.

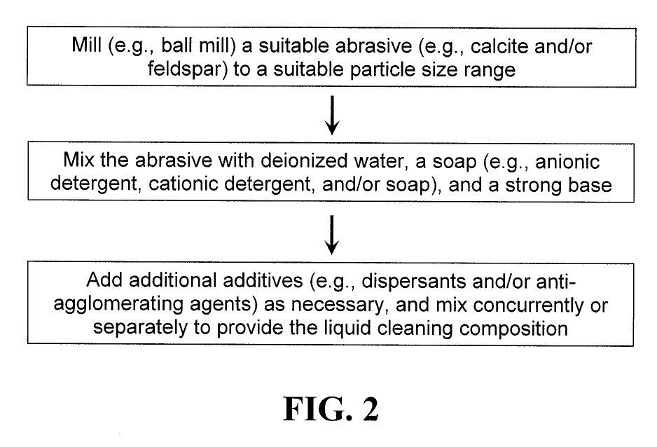

FIG. 2 is a block diagram that exemplifies a general process by which another exemplary embodiment of a liquid cleaning composition can be prepared. This alternative embodiment of the present invention can be prepared as follows. Suitable abrasives, such as feldspar and/or calcite, can be obtained from a minerals distributor. The abrasives can be milled (e.g., ball milled) and classified (e.g., sieved) to obtain a suitable particle size range. Additionally, suitable soaps (e.g., sodium tallowate) can be obtained from various chemical companies. A strong base, such as NaOH, may also be obtained from various chemical companies. The abrasive, soap, strong base and water may be combined, in the appropriate amounts, and mixed, to provide an exemplary liquid cleaning composition. Additional additives, such as suitable dispersants and anti-agglomerating agents may be added to the liquid cleaning composition. The additives may render the liquid cleaning composition user-friendly on the factory floor and stable with time (i.e., has a reasonable shelf-life). TSP may further be added to the liquid cleaning composition to enhance its cleaning ability.

FIGS. 3 and 4 are block diagrams that exemplify general processes by which a material can be cleaned using a cleaning composition according to embodiments of the present invention, and then bonded with an adhesive to another material (as shown in FIG. 3) or coated with an inorganic thermal control coating (as shown in FIG. 4). As can be seen in FIGS. 3 and 4, the liquid cleaning composition according to embodiments of the present invention may be used in the following manner. The bottle containing the liquid cleaning composition may be shaken prior to use. The bottle may be shaken frequently, as the solids tend to settle quickly. The liquid cleaning composition may be added liberally to the part (i.e., material) to be cleaned. A plastic squeeze bottle may be used to dispense the liquid cleaner. The liquid cleaning composition may be scrubbed on the part. Maroon Norton Bear-Tex abrasive pads (very fine) or gray Norton Bear-Tex abrasive pads (micro fine) may be used to scrub the part. A cloth pad, such as Texwipe Tex. 309, may also be used to scrub the part, for example, in cases where one does not want to expose the ends of the carbon fibers in carbon fiber reinforced epoxy matrix composites.

The liquid cleaning composition may be used liberally, but water should not be added to the liquid cleaning composition while cleaning the part. Adding water to the liquid cleaning composition while cleaning the part will dilute the liquid cleaning composition and will deteriorate the performance of the liquid cleaning composition. The part may then be rinsed with water (e.g., tap water). The dissolved minerals in, for example, tap water, help to remove the initial significant quantities of soap and abrasives. After being rinsed with water, such as tap water, the part may subsequently be rinsed with deionized water to remove the cleaner, any dirt residues, and any dissolved minerals, such as those from tap water. Subsequently, the part may be dried (e.g., dried with compressed nitrogen gas or filtered air, or air dried). The part should now be substantially free of silicone contaminants, clean, and ready for bonding with adhesives (as shown in FIG. 3) or coating with paints (as shown in FIG. 4). That is, an inorganic thermal control coating may be directly sprayed on the part (as shown in FIG. 4), if the part is a metal substrate, such as an aluminum alloy.

As an example of the above-described method, an aluminum alloy substrate was deliberately contaminated with silicone oil (i.e., polydimethylsiloxane). A liquid cleaning composition, which included NaOH, was then applied to the contaminated substrate, followed by coating with an inorganic white thermal control coating. The present inventor believes that the silicone oil was attacked by the NaOH. After being treated with the liquid cleaning composition, the deliberately contaminated aluminum substrates showed excellent adhesion to the inorganic thermal control coating. No failures of the inorganic coating were recorded.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A liquid cleaning composition comprising:
a strong base of a type and in an amount sufficient to break down silicone oil;
a soap compatible with a high pH environment;
an abrasive stable in a high pH environment; and
water.

2. The liquid cleaning composition of claim 1, wherein the strong base is selected from the group consisting of sodium hydroxide (NaOH), potassium hydroxide (KOH), lithium hydroxide (LiOH), and trisodium phosphate (TSP).

3. The liquid cleaning composition of claim 1, wherein the strong base is present in the liquid cleaning composition in an amount in a range of about 1 to about 10% by weight based on the total weight of the liquid cleaning composition.

4. The liquid cleaning composition of claim 3, wherein the strong base is present in the liquid cleaning composition in amount of about 3% by weight based on the total weight of the liquid cleaning composition.

5. The liquid cleaning composition of claim 1, wherein the soap is present in the liquid cleaning composition in an amount in a range of about 1 to about 10% by weight based on the total weight of the liquid cleaning composition.

6. The liquid cleaning composition of claim 1, wherein the abrasive is present in the liquid cleaning composition in amount in a range of about 10 to about 25% by weight based on the total weight of the liquid cleaning composition.

7. The liquid cleaning composition of claim 1, wherein the abrasive and the soap are present in the liquid cleaning composition in a combined amount of about 20% by weight based on the total weight of the liquid cleaning composition.

8. The liquid cleaning composition of claim 1, wherein water is present in the liquid cleaning composition in an amount in a range of about 60 to about 85% by weight based on the total weight of the liquid cleaning composition.

9. The liquid cleaning composition of claim 1, wherein water is present in the liquid cleaning composition in an amount of about 77% by weight based on the total weight of the liquid cleaning composition.

10. The liquid cleaning composition of claim 1, wherein the abrasive comprises calcite.

11. The liquid cleaning composition of claim 1, wherein the abrasive comprises feldspar.

12. The liquid cleaning composition of claim 1, wherein the abrasive comprises calcite and feldspar.

13. The liquid cleaning composition of claim 1, wherein the soap comprises an alkali salt of a fatty acid.

14. The liquid cleaning composition of claim 1, wherein the soap comprises sodium tallowate.

15. The liquid cleaning composition of claim 1, wherein the liquid cleaning composition has a pH greater than or equal to about 11.

16. A method of cleaning a material, the method comprising:
applying the liquid cleaning composition according to claim 1 to the material;
scrubbing the material with the liquid cleaning composition;
rinsing the material with water;
rinsing the material with deionized water; and
drying the material.

17. The method of claim 16, wherein the material comprises a material selected from the group consisting of glass fiber reinforced epoxy matrix composites and graphite fiber reinforced epoxy matrix composites, or a metal selected from the group consisting of aluminum, aluminum alloys, titanium, titanium alloys, beryllium, beryllium alloys, and combinations thereof.

18. The method of claim 16, wherein cleaning the material removes silicone oil contamination and prepares the material for bonding.

19. A method of bonding a material, the method comprising:
cleaning the material according to the method of claim 16; and
bonding the material to an inorganic thermal control coating.

20. The method of claim 19, wherein the inorganic thermal control coating comprises a potassium silicate binder based coating.

21. A liquid cleaning composition comprising:
a strong base of a type and in an amount sufficient to break down silicone oil;
a soap of a type and in an amount to avoid excessive foaming;
a friable abrasive; and
water.

22. A liquid cleaning composition comprising:
a strong base of a type and in an amount sufficient to break down silicone oil;
a detergent compatible with a high pH environment;
an abrasive stable in a high pH environment; and
water.

23. A liquid cleaning composition comprising:
a strong base of a type and in an amount sufficient to break down silicone oil;
a detergent of a type and in an amount to avoid excessive foaming;
a friable abrasive; and
water.
